(19) United States
(12) Patent Application Publication
(10) Pub. No.: US 2026/0004666 A1
(43) Pub. Date: Jan. 1, 2026

(54) GUIDANCE METHOD AND SYSTEM FOR CALCULATING COURSE CORRECTION WHEN NAVIGATING USING UNINTENDED RADIO FREQUENCY OR RADIATIVE EMISSIONS

(71) Applicant: Argus Industrial, LLC, Moon Township, PA (US)

(72) Inventors: Samuel G. Brown, Sandersville, GA (US); Dmytro Parkhomenko, Zaporizhzhia (UA)

(21) Appl. No.: 19/252,834

(22) Filed: Jun. 27, 2025

Related U.S. Application Data
(60) Provisional application No. 63/664,885, filed on Jun. 27, 2024.

(51) Int. Cl. G08G 5/57; G01S 5/02

(52) U.S. Cl. CPC G08G 5/57; G01S 5/021

(57) ABSTRACT

A guidance method and system for calculating course correction when navigating includes using unintended radio frequency and/or unintended radiative emissions The guidance method and system for calculating course correction when navigating using unintended radio frequency and/or radiative emissions may generally include sensing the unintended radio frequency and/or unintended radiative emissions and then utilizing the sensed unintended radio frequency and/or the sensed unintended radiative emissions for navigation. The unintended radio frequency and/or the unintended radiative emissions sensed and utilized for guidance includes non-standard, ambient, third-party, or other radio frequencies or radiative emissions not originally designed for navigational purposes. Wherein, the utilizing the sensed unintended radio frequency and/or the sensed unintended radiative emissions includes calculating course corrections via the sensed unintended radio frequency and/or the unintended radiative emissions.

### CROSS-REFERENCE TO RELATED APPLICATIONS

This application claims benefit to U.S. Provisional Patent Application No. 63/664,885 filed on Jun. 27, 2024, entitled GUIDANCE METHOD AND SYSTEM FOR CALCULATING COURSE CORRECTION WHEN NAVIGATING USING RADIO FREQUENCY/RADIATIVE EMISSIONS which is incorporated by reference in its entirety.

### FIELD OF THE DISCLOSURE

The present disclosure may be related to guidance methods and system for various un-manned aerial systems (UAS) or other vehicles, vessels, or aircrafts. More specifically, the present disclosure may be directed to a guidance method and system for calculating course correction when navigating using unintended radio frequency and/or radiative emissions.

### BACKGROUND

Generally speaking, a guidance system is a virtual or physical device, or a group of devices implementing and controlling the movement of a ship, aircraft, missile, rocket, satellite, or any other moving object, including, but not limited to a UAS. Guidance is the process of calculating the changes in position, velocity, altitude, and/or rotation rates of a moving object required to follow a certain trajectory and/or altitude profile based on information about the object's state of motion. A guidance system is usually part of a guidance, navigation and control system, whereas navigation refers to the systems necessary to calculate the current position and orientation based on sensor data like those from compasses, GPS receivers, Loran-C, star trackers, inertial measurement units, altimeters, etc. The output of the navigation system, the navigation solution, is an input for the guidance system, among others like the environmental conditions, like wind, water, temperature, etc., and the vehicle's characteristics. In general, the guidance system computes the instructions for the control system, which comprises the object's actuators (e.g., thrusters, reaction wheels, body flaps, etc.), which are able to manipulate the path and orientation of the object without direct or continuous human control. As such, a guidance system has three major sub-sections: inputs, processing, and outputs. The input section includes sensors, course data, radio and satellite links, and other information sources. The processing section, composed of one or more CPUs, integrates this data and determines what actions, if any, are necessary to maintain or achieve a proper heading. This is then fed to the outputs which can directly affect the system's course. The outputs may control speed by interacting with devices such as turbines, and fuel pumps, or they may more directly alter course by actuating ailerons, rudders, or other devices.

A UAS, also known as an unmanned aerial vehicle (UAV), and commonly known as a drone, is an aircraft with no human pilot, crew, or passengers on board, but rather is controlled remotely or is autonomous. Uses for a UAS are limitless and may include military applications, aerial photography, area coverage, precision agriculture, forest fire monitoring, river monitoring, environmental monitoring, weather observation, policing and surveillance, infrastructure inspections, smuggling, product deliveries, entertainment and drone racing.

Modern system hardware for UAS control is often called the flight controller (FC), flight controller board (FCB) or autopilot. Common UAS-systems control hardware typically incorporate a primary microprocessor, a secondary or failsafe processor, and sensors such as accelerometers, gyroscopes, magnetometers, and barometers into a single module. UASs use a radio for control and exchange of video and other data. Early UASs had only narrowband uplink. Downlinks came later. These bi-directional narrowband radio links carried command and control (C&C) and telemetry data about the status of aircraft systems to the remote operator. In most modern UAS applications, video transmission is required. So instead of having separate links for C&C, telemetry and video traffic, a broadband link is used to carry all types of data. The radio signal from the operator side can be issued from either: ground control (a human operating a radio transmitter/receiver, a smartphone, a tablet, a computer, or the original meaning of a military ground control station (GCS); a remote network system (such as satellite duplex data links for some military powers, downstream digital video over mobile, direct UAV control uplink over the cellular mesh and LTE networks, or the like); or another aircraft, serving as a relay or mobile control station (military manned-unmanned teaming (MUM-T)). As an example, UAS-to-UAS coordination supported by Remote ID communication technology can be used for remote ID messages (containing the UAV coordinates) broadcast and used for collision-free navigation

The instant disclosure recognizes the development of counter unmanned air system (C-UAS) technologies with a variety of counter-UAS (C-UAS) systems developed globally to address the growing threat of small and tactical UAVs. Automatic tracking and detection of UASs from commercial cameras have become accurate thanks to the development of deep learning based machine learning algorithms. It is also possible to automatically identify UASs across different cameras with different viewpoints and hardware specification with re-identification methods. Once a UAS is detected, it can be countered with kinetic force (missiles, projectiles or another UAS) or by non-kinetic force including, laser, microwaves, and communications jamming. As such, modern C-UAS systems include multi-layered approaches combining radar, electro-optical sensors, radio frequency detection, and jamming technologies.

Communications jamming and jamming technologies are designed to deliberately block or interference with wireless communications. Radar jamming and deception is a form of electronic countermeasures (ECMs) that intentionally sends out radio frequency signals to interfere with the operation of radar by saturating its receiver with noise or false information. Concepts that blanket the radar with signals so its display cannot be read are normally known as jamming, while systems that produce confusing or contradictory signals are known as deception, but it is also common for all such systems to be referred to as jamming. As such, there is clearly a need to provide navigation of a UAS, or other vehicle, ship, vessel, or the like, when C-UAS systems or the like, when jamming technologies or the like prevent or jam communications with the UAS (or other vehicle, ship, vessel, or the like) thereby preventing standard navigation.

The instant disclosure may be designed to address at least certain aspects of the problems or needs discussed above by providing a guidance method and system for calculating course correction when navigating using unintended radio frequency and/or radiative emissions.

### SUMMARY

The present disclosure may solve the aforementioned limitations of the currently available guidance methods and systems, by providing the disclosed guidance method and system for calculating course correction when navigating using unintended radio frequency and/or radiative emissions. The disclosed guidance method for calculating course correction when navigating using unintended radio frequency and/or radiative emissions may generally include sensing an unintended radio frequency and/or unintended radiative emissions. Once the unintended radio frequency and/or the unintended radiative emissions are sensed, the guidance method may then include utilizing the sensed unintended radio frequency and/or the sensed unintended radiative emissions for navigation. The unintended radio frequency and/or the unintended radiative emissions sensed and utilized for guidance including non-standard, ambient, third-party, or other radio frequencies or radiative emissions not originally designed for navigational purposes. Wherein, the utilizing the sensed unintended radio frequency and/or the sensed unintended radiative emissions includes calculating course corrections via the sensed unintended radio frequency and/or the unintended radiative emissions.

One feature of the disclosed guidance method may be that the calculating course corrections using the sensed unintended radio frequency and/or the sensed unintended radiative emissions may include triangulating the sensed unintended radio frequency and/or the sensed unintended radiative emissions. In select embodiment, the guidance method may include providing two pairs of directional antennas. With these two pairs of directional antennas provided, the triangulation of the sensed unintended radio frequency and/or sensed unintended radiative emissions may include triangulating the sensed unintended radio frequency and/or the sensed unintended radiative emissions via the provided two pairs of directional antennas. In other select embodiments, the guidance method may include providing the two pairs of directional antennas and one omni-directional antenna. With these two pairs of directional antennas provided and the one omni-directional antenna, the triangulation of the sensed unintended radio frequency and/or sensed unintended radiative emissions may include triangulating the sensed unintended radio frequency and/or the sensed unintended radiative emissions via the provided two pairs of directional antennas, while simultaneously deducing relative distance to unintended radio emission source using the single omni-directional antenna by sensing the perceived signal strength or received signal strength indicator (RSSI) value.

In select embodiments of the disclosed guidance method, an onboard operation or flight computer may be provided, like an onboard flight computer of a UAS. With the provided onboard operation or flight computer, the guidance method may include calculating variations in signal strength from the two pairs of directional antennas and necessary course corrections required to optimize the antennas response per a desired flight profile via the onboard operation or flight computer. In select embodiments, the provided two pairs of directional antennas may be diametrically opposed antennas, and may include one single omni-directional antenna. The two pairs of diametrically opposed directional antennas may be configured for receiving electromagnetic radiation and a measure of signal strength and a frequency in gain and radiation intensity about a direction of travel, and for outputting the measure of signal strength and the frequency in the gain and the radiation intensity, while the single omni-directional antenna deduces relative distance to unintended radio emission source by sensing the perceived signal strength or received signal strength indicator (RSSI) value.

Wherein, the guidance method may include: outputting steering right to the onboard operation or flight computer if the triangulation of the signal strength of the sensed unintended radio frequency and/or the sensed unintended radiative emissions is on the right of the direction of travel; outputting steering down to the onboard operation or flight computer if the triangulation of the signal strength of the sensed unintended radio frequency and/or the sensed unintended radiative emissions is down of the direction of travel; outputting steering left to the onboard operation or flight computer if the triangulation of the signal strength of the sensed unintended radio frequency and/or the sensed unintended radiative emissions is on the left of the direction of travel; outputting steering up to the onboard operation or flight computer if the triangulation of the signal strength of the sensed unintended radio frequency and/or the sensed unintended radiative emissions is up of the direction of travel; outputting maintaining course to the operation or onboard flight computer if the triangulation of the signal strength of the sensed unintended radio frequency and/or the sensed unintended radiative emissions has no directional input; and/or combinations thereof.

Another feature of the disclosed guidance method may be that the triangulation of the sensed unintended radio frequency and/or the sensed unintended radiative emissions may include conducting terminal navigation to the sensed unintended radio frequency and/or the sensed unintended radiative emissions. In select embodiments, the sensed unintended radio frequency and/or the sensed unintended radiative emissions may be a specific electromagnetic radiation source associated with common frequency ranges of radio and/or radar. Wherein, the triangulating the sensed unintended radio frequency and/or the sensed unintended radiative emissions may include triangulating the specific electromagnetic radiation source. Likewise, the conducting terminal navigation to the sensed unintended radio frequency and/or the sensed unintended radiative emissions may include conducting terminal navigation to the specific electromagnetic radiation source. Wherein, the guidance method may be configured to enable navigating to a signal of interest with the specific electromagnetic radiation source where a global positioning system is not available or is degraded. Wherein the guidance method may be configured to enable precision location of the specific electromagnetic radiation source of electromagnetic emissions configured for the purposes of navigating a vehicle, for the purposes of, but not limited to, safe fuzing of an ordinance, or for other purposes which utilize a location of said electromagnetic emissions from said specific electromagnetic radiation source.

In select embodiments, the disclosed guidance method may include a cycle of: measuring a signal strength of the sensed unintended radio frequency and/or the sensed unintended radiative emissions at all of the antennas; evaluating which direction to apply course corrections or steering; applying course correction based on a calculated heading change and airframe input factors and/or flight constants; stabilizing flight in new direction; and reacquiring the signal strength, comparing old course to a new course heading, and calculating expected signal strength at all of the antennas.

Another feature of the disclosed guidance method may be that in select embodiments it can include providing an Artificial Intelligence (AI) and/or Machine Learning (AIML) computer. The AI and/or AIML computer provided may be capable of optimizing calculated course corrections and learning responses over time based on user programmed or other inputs. With this AI and/or AIML computer provided, the disclosed guidance method may further include using AI and/or (AIML) software on the provided AI and/or AIML computer. Wherein, the using the AI and/or AIML software can include: learning, identifying, and prioritizing a variety of signals in the electromagnetic spectrum available to it in order to make decisions based on the likelihood of the signal being weak or not valuable or useful to the guidance method; discarding a signal not of interest; prioritizing strong or certain signals in a specific frequency range, spectrum, or both; and reporting signal strengths back to a user or other location of interest in order to catalog the strong or certain signals, the signals not of interest to discard, or other parameters. Wherein, utilizing the provided AI and/or AIML computer and software, the guidance method may further include, after measuring the signal strength at all of the antennas, reporting the signal strength measured to the onboard operation or flight computer for processing via the AI and/or AML software on the AI and/or AIML computer. Likewise, utilizing the provided AI and/or AIML computer and software, the guidance method may further include, after applying the course correction, reporting the signal strength and the course correction to the onboard computer for processing via the AI and/or AML software on the AI and/or AIML computer.

Another feature of the disclosed guidance method may be that the utilizing the sensed unintended radio frequency and/or the sensed unintended radiative emissions for navigation is configured for navigation of a vehicle, including any type of vehicle. Wherein, the guidance method may further include providing a connection to operation or flight controls or an onboard operation or flight computer of the vehicle through which to affect the instructions for navigation of the vehicle. Wherein the vehicle utilizing the disclosed guidance method may be, but is not limited to, an un-manned aerial system (UAS), a land vehicle, a vessel, an aircraft, or a system. Wherein, the guidance method may further include guiding the UAS, the land vehicle, the vessel, the aircraft or the system via the sensed unintended radio frequency and/or the sensed unintended radiative emissions. Wherein, the guidance method further include providing the connection to operation or flight controls or an onboard flight computer of the UAS, the land vehicle, the vessel, the aircraft or the system through which to affect the instructions for navigation.

In select possibly preferred embodiments, the disclosed guidance method may be designed and configured for a UAS. Wherein, the guidance method may include guiding the UAS via the sensed unintended radio frequency and/or the sensed unintended radiative emissions. Wherein, the guidance method may further include providing the connection to operation or flight controls or the onboard flight computer of the UAS through which to affect the instructions for flight navigation to provide an ideal path and optical control inputs, whereby the guidance method is configured to provide a desired trajectory and path for the UAS, like for terminal navigation.

Another feature of the disclosed guidance method may be that it can further include retrofitting the vehicle with a guidance system. The guidance system retrofitted on the vehicle may include the antennas configured for the sensing of the unintended radio frequency and/or radiative emissions. Wherein, in select embodiments, the retrofitting the vehicle with the guidance system with antennas configured for the sensing of the unintended radio frequency and/or radiative emissions may include providing a housing device or construction of a housing configured for housing the guidance system including the antennas and an onboard operation or flight computer with connection to the operation or flight controls of the vehicle in order to retrofit, add the capability to, or to install from the outset the capability to detect electromagnetic radiation, to direct the vehicle toward the electromagnetic radiation. Wherein, the provided housing device may be configured to enable a user to retrofit the guidance system for the guidance method onto an existing vessel, vehicle, aircraft or system to effectuate directional control over the existing vessel, vehicle, aircraft, or system in response to electromagnetic signal strengths, frequencies, and other parameters.

In another aspect, the instant disclosure embraces a guidance system configured for carrying out the disclosed guidance method in any of the embodiments and/or combinations of embodiments shown and/or described herein. As such, the guidance system may be configured to provide navigation to a vehicle via sensed unintended radio frequency and/or sensed unintended radiative emissions. The disclosed guidance system may thus generally include antennas configured to sense the unintended radio frequency and/or the unintended radiative emissions. The disclosed guidance system may also include an onboard operation or flight computer configured to triangulate the unintended radio frequency and/or the unintended radiative emissions sensed by the antennas. A connection between the onboard operation or flight computer and an operational control system of the vehicle may also be provided with the disclosed guidance system. Wherein, the guidance system may be configured to utilize the triangulation of the unintended radio frequency and/or the unintended radiative emissions sensed by the antennas for calculating course corrections for providing navigation to the vehicle.

In select embodiments of the disclosed guidance system, the antennas may include two pairs of diametrically opposed directional antennas. The two pairs of diametrically opposed directional antennas may be configured to sense the unintended radio frequency and/or the unintended radiative emissions. In other select embodiments of the disclosed guidance system, the antennas may include two pairs of diametrically opposed directional antennas, and one omni-directional antenna. The two pairs of diametrically opposed directional antennas may be configured to sense the unintended radio frequency and/or the unintended radiative emissions, and the omni-directional antenna may be configured to simultaneously sense the RSSI value of the unintended radio frequency and/or unintended radiative emissions.

In select embodiments, the disclosed guidance system may also include a housing device or construction of a housing. The housing device or construction of a housing may be configured for housing components of the guidance system including, but not limited to, the antennas and the onboard operation or flight computer with connection to the operation or flight controls of the vehicle. The housing device or construction of the housing configured for housing the components of the guidance system may be configured to allow the guidance system to be retrofitted to the vehicle, add the guidance method capability to the vehicle, or to install from the outset the capability to detect electromagnetic radiation, to direct the vehicle toward the electromagnetic radiation.

In select possibly preferred embodiments of the disclosed guidance system, the vehicle may be an un-manned aerial system (UAS). In these embodiments, the onboard flight computer may be connected to the flight controls. Wherein, the housing device may be a nose cone configured to house the antennas and the onboard flight computer with connections to the flight controls of the UAS.

In another aspect, the instant disclosure embraces an un-manned aerial system (UAS) including the disclosed guidance system and/or guidance method in any of the embodiments and/or combinations of embodiments shown and/or described herein. As such, the disclosed UAS may generally include the disclosed guidance system configured to provide navigation to the UAS. The guidance system included in the UAS may include two pairs of diametrically opposed directional antennas configured to sense unintended radio frequency and/or unintended radiative emissions. Wherein, the guidance system of the UAS may be configured to triangulate the sensed unintended radio frequency and/or radiative emissions from the two pairs of directional antennas and utilize the sensed unintended radio frequency and/or radiative emissions for calculating course corrections for providing navigation to the UAS. In select embodiments, the guidance system of the UAS may also include an omni-directional antenna. The omni-directional antenna may be configured to sense the RSSI value of the unintended radio frequency and/or unintended radiative emissions.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

The present disclosure will be better understood by reading the Detailed Description with reference to the accompanying drawings, which are not necessarily drawn to scale, and in which like reference numerals denote similar structure and refer to like elements throughout, and in which:

FIG. 1 is a flowchart of the disclosed guidance method according to select embodiments of the instant disclosure showing an example of the type of data that is measured and the outputs that are calculated while the vehicle, vessel, or aircraft is in motion with the electromagnetic signal strength being measured and or calculated by the User or vehicle, vessel, or aircraft in order to continue their travel navigating using signal strength as a key part of its means of navigating;

FIG. 2 is a diagram of processes for the disclosed guidance method according to select embodiments of the instant disclosure showing examples of the comparison of the signal strength measurements that could be measured using this navigation method and the generic inputs that the User or operational or flight computer could recommend in response to these signal strength measurements as the vehicle, vessel, aircraft, or system operates in an environment where other means of navigating are limited, such as GPS or visual navigation;

FIG. 3 is a perspective partial view of the cone of a UAS with the disclosed guidance system according to select embodiments of the instant disclosure showing possible placements of the antennas on a notional nosecone of an aircraft which could be in-flight and measuring the signal strength and calculating navigational inputs based on the method shown in FIGS. 1-2.

FIG. 4 is a diagram with the partial view of the cone of a UAS with the disclosed guidance system from FIG. 3 showing the guidance system operating as if attached to an aircraft and being presented with a directional electromagnetic signal, this pictorial representation showing the anticipated signal strength which would be measured when flying in such relationship to the signal above the signal emitter, and based on the signal strength shown the disclosed guidance method would recommend or direct the control system to adjust its course with steering corrections in order to optimize the signal strength distribution;

FIG. 5 is a diagram with the partial view of the cone of a UAS with the disclosed guidance system from FIG. 3 showing the disclosed guidance system operating as if attached to an aircraft and being presented with an omnidirectional electromagnetic signal, this pictorial representation showing the anticipated signal strength which would be measured when flying in such relationship to the signal below the signal, and based on the signal strength shown the present method would recommend or direct the control system to adjust its course with steering corrections in order to optimize the signal strength distribution; and

FIG. 6 is a diagram of the anticipated possible trajectories of the same object using the disclosed guidance method of FIGS. 1-2 (Path 4) and other trajectories that do not use the present invention or method (Paths 1, 2, 3, 5, 6, 7, and 8), where the anticipated improvement in path is a result of the disclosed guidance method and its ability to optimize the flight path of a given vehicle, vessel, aircraft, or system based on the expectation that all systems have a finite amount of energy, momentum, fuel, electrical power, or other motive energy and as such optimizing the system's ability to navigate using the disclosed guidance system and guidance method to increase the total distance that said system could travel before expending its motive energy.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

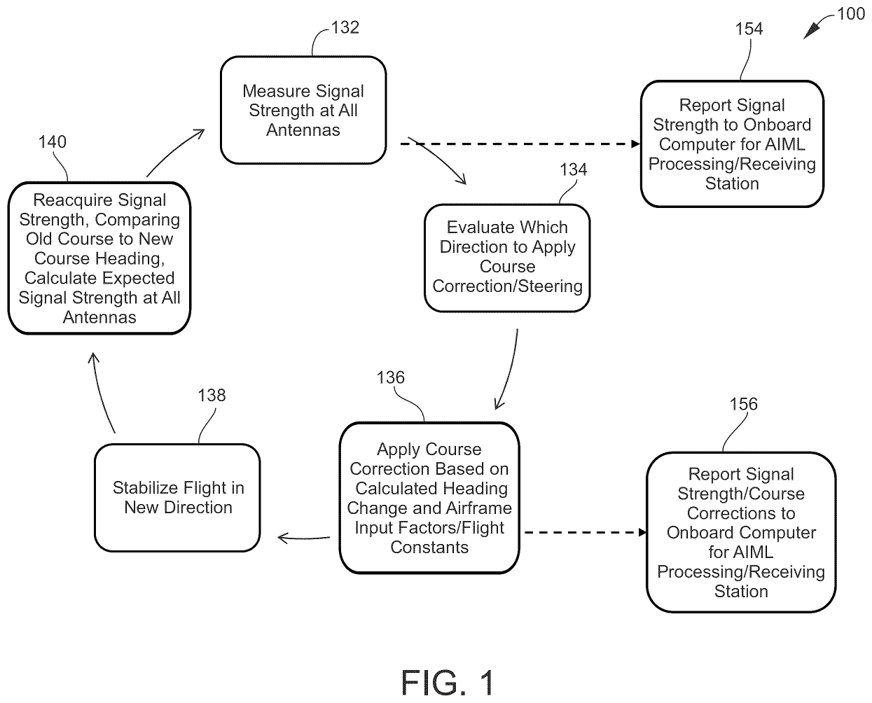

Referring now to FIGS. 1-6, in describing the exemplary embodiments of the present disclosure, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples and are merely examples among other possible examples.

Referring to FIGS. 1-6, the present disclosure may solve the aforementioned limitations of the currently available navigation methods and systems by providing the disclosed guidance method 100 and guidance system 10 for calculating course correction when navigating using unintended radio frequency 14 or unintended radiative emissions 16. As used herein, unintended radio frequency 14 and/or unintended radiative emissions 16 shall be any third party, non-standard, ambient, or other radio/source or emission. Although there has been some know uses of radio navigation beacons for aircraft, like very high frequency omnidirectional range stations (VOR) and VORTAC (radio-based navigational aid for aircraft pilots consisting of a co-loaded VHF omnidirectional range and a tactical air navigation system (TACAN) beacon), the instant disclosure is directed to utilizing existing unintended radio frequencies 14 or unintended radiative emissions 16 that were not intended to be used for navigational purposes (like VOR and/or VORTAC). In other words, as used herein, the unintended radio frequency 14 or unintended radiative emissions 16 utilized by the instant disclosure of guidance method 100 and guidance system 10 may be existing radio emissions that a third-party would have been using for an entirely different purpose. The disclosed guidance method 100 and guidance system 10 may be designed and configured to target/harness those navigationally unrelated emissions, and use such navigationally unrelated or unintended emissions as a navigational point (including terminally so when talking about jammers).

Guidance method 100 and guidance system 10 for calculating course correction when navigating using unintended radio frequency 14 and/or radiative emissions 16 may generally include process 110 of sensing unintended radio frequency 14 and/or unintended radiative emissions 16. Guidance method 100 may include any devices, steps, and/or means for sensing unintended radio frequency 14 and/or radiative emissions 16, including, but not limited to, by using pairs 12 (12a and 12b representing distinct pairs) of diametrically opposed directional antennas 28, as shown herein, and an omni-directional antenna 28 configured to sense the RSSI value of the unintended radio frequency and/or unintended radiative emissions. Once the unintended radio frequency 14 and/or the unintended radiative emissions 16 is/are sensed, guidance method 100 may then include process 120 for utilizing the sensed unintended radio frequency 14 and/or the sensed unintended radiative emissions 16 for navigation. Guidance method 100 may include any devices, steps, and/or means for utilizing the sensed unintended radio frequency 14 and/or the sensed unintended radiative emissions 16 for navigational purposes. The unintended radio frequency 14 and/or the unintended radiative emissions 16 sensed and utilized for guidance may include non-standard, ambient, third-party, or other radio frequencies or radiative emissions not originally designed for navigational purposes. Wherein, process 120 of utilizing the sensed unintended radio frequency 14 and/or the sensed unintended radiative emissions 16 may include process 122 for calculating course corrections 24 via the sensed unintended radio frequency 14 and/or the unintended radiative emissions 16. Guidance method 100 may include any devices, steps, and/or means for calculating course corrections 24 via the sensed unintended radio frequency 14 and/or the unintended radiative emissions 16.

One feature of the guidance method 100 and guidance system 10 disclosed herein, may be that process 122 for calculating course corrections using the sensed unintended radio frequency 14 and/or the sensed unintended radiative emissions 16 may include triangulating the sensed unintended radio frequency 14 and/or the sensed unintended radiative emissions 16. Triangulation of the sensed unintended radio frequency 14 and/or the sensed unintended radiative emissions 16 may be done by any means, devices, steps, etc. In select possibly preferred embodiments, as shown herein, guidance method 100 and guidance system 10 may include providing two pairs 12 (12a and 12b representing separate pairs) of directional antennas 28. With these two pairs 12 of directional antennas 28 provided, the triangulation of the sensed unintended radio frequency 14 and/or sensed unintended radiative emissions 16 may include triangulating the sensed unintended radio frequency 14 and/or the sensed unintended radiative emissions 16 via the provided two pairs 12 of directional antennas 28. In select possibly most preferred embodiments, guidance method 100 and guidance system 10 may include providing two pairs 12 (12a and 12b representing separate pairs) of directional antennas 28 and omni-directional antenna 28. With these two pairs 12 of directional antennas 28 and the omnidirectional antenna provided, the triangulation of the sensed unintended radio frequency 14 and/or sensed unintended radiative emissions 16 may include triangulating the sensed unintended radio frequency 14 and/or the sensed unintended radiative emissions 16 via the provided two pairs 12 of directional antennas 28, while the omni-directional antenna 28 simultaneously deduces relative distance to a sensed unintended radio emission source using the single omni-directional antenna 28 by sensing a perceived signal strength or a received signal strength indicator (RSSI) value. Omni-directional antenna 28 may be configured to measure phase shift using reflectors or the like.

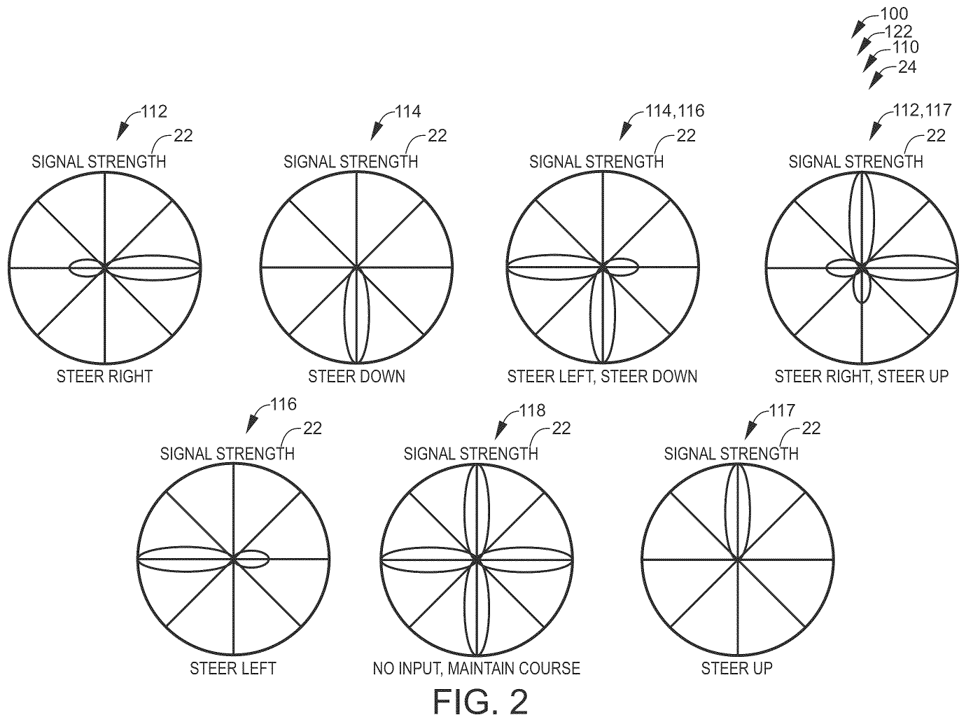

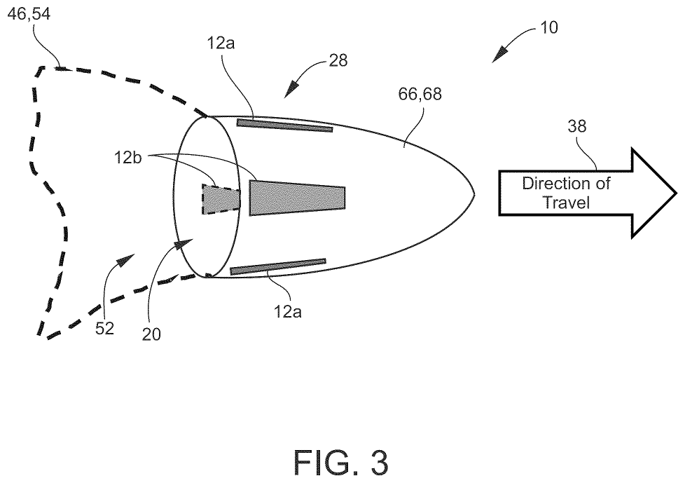

In select embodiments of the disclosed guidance method 100 and/or guidance system 10, an onboard operation or flight computer 20 may be provided, like an onboard flight computer 20 of UAS 54, as shown in FIGS. 3-5. With the provided onboard operation or flight computer 20, the guidance method 100 and/or guidance system 10 may include calculating variations in signal strength 22 from the two pairs 12 of directional antennas 28 (and one omni-directional antenna 28 if included) and necessary course corrections 24 required to optimize the antennas 28 response per a desired flight profile 26 via the onboard operation or flight computer 20. In select embodiments, the provided two pairs 12 of directional antennas 28 may be diametrically opposed antennas 28. The two pairs 12 of diametrically opposed directional antennas 28 may be configured for receiving electromagnetic radiation 30 and measure of signal strength 32 and frequency in gain 34 and radiation intensity 36 about a direction of travel 38, and for outputting the measure of signal strength 32 and the frequency in the gain 34 and the radiation intensity 36. Wherein, as shown in FIG. 2, and clearly not limited thereto, guidance method 100 and/or guidance system 10 may include: process 112 of outputting steering right to onboard operation or flight computer 20 if the triangulation of the signal strength 22 of the sensed unintended radio frequency 14 and/or the sensed unintended radiative emissions 16 is on the right of the direction of travel 38; process 114 of outputting steering down to the onboard operation or flight computer 20 if the triangulation of the signal strength 22 of the sensed unintended radio frequency 14 and/or the sensed unintended radiative emissions 16 is down of the direction of travel 38; process 116 of outputting steering left to the onboard operation or flight computer 20 if the triangulation of the signal strength 22 of the sensed unintended radio frequency 14 and/or the sensed unintended radiative emissions 16 is on the left of the direction of travel 38; process 117 of outputting steering up to the onboard operation or flight computer 20 if the triangulation of the signal strength 22 of the sensed unintended radio frequency 14 and/or the sensed unintended radiative emissions 16 is up of the direction of travel 38; process 118 of outputting maintaining course to the operation or onboard flight computer 20 if the triangulation of the signal strength 22 of the sensed unintended radio frequency 14 and/or the sensed unintended radiative emissions 16 has no directional input; the like; and/or combinations thereof. As additional examples, and clearly not limited thereto, as shown in FIG. 2, guidance method 100 and/or guidance system 10 may include: a process of outputting steering left and down to onboard operation or flight computer 20 if the triangulation of the signal strength 22 of the sensed unintended radio frequency 14 and/or the sensed unintended radiative emissions 16 is on the left and down side of the direction of travel 38; and a process of outputting steering right and up to onboard operation or flight computer 20 if the triangulation of the signal strength 22 of the sensed unintended radio frequency 14 and/or the sensed unintended radiative emissions 16 is on the right and up side of the direction of travel 38.

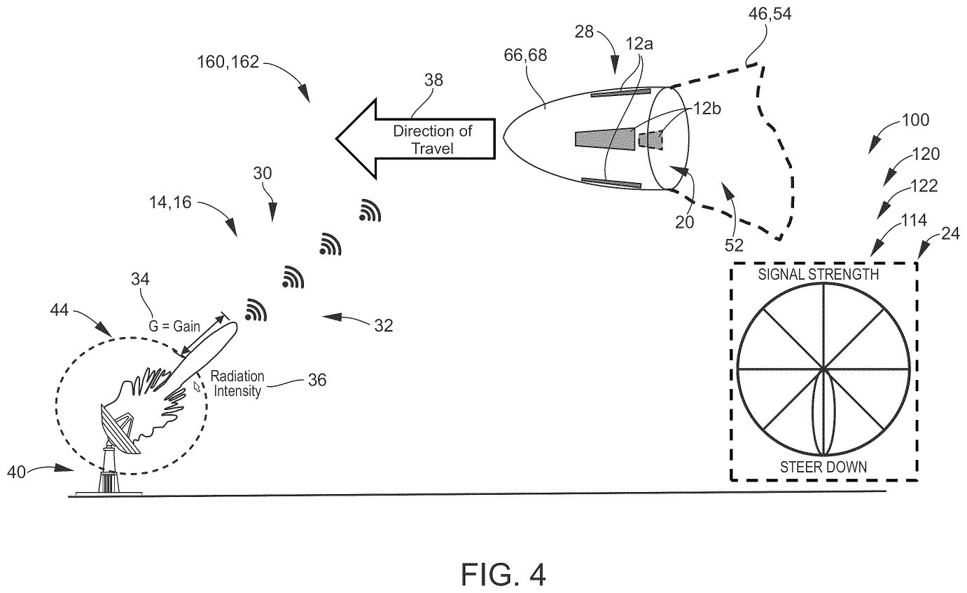

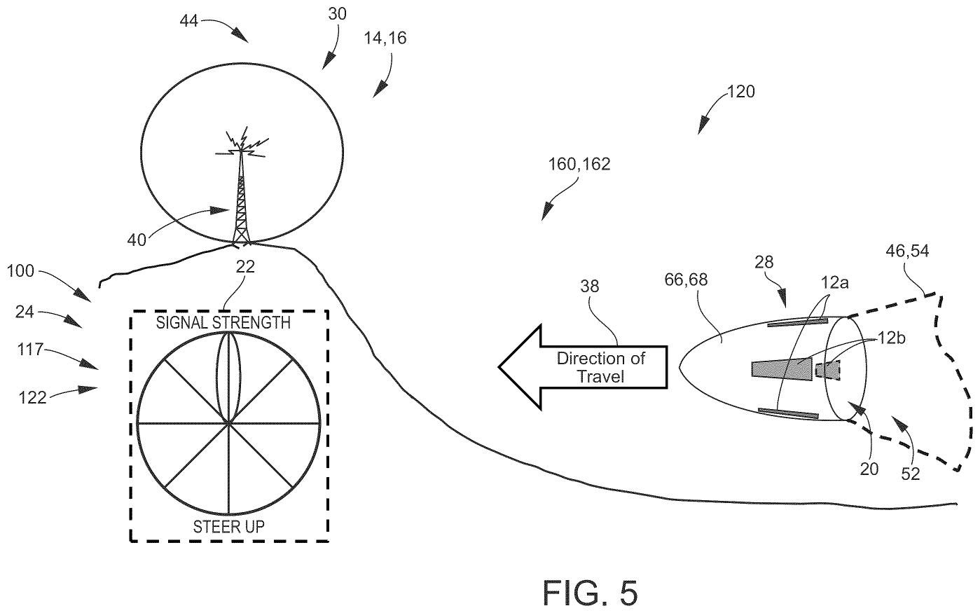

Another feature of the disclosed guidance method 100 and/or guidance system 10 may be that the triangulation of the sensed unintended radio frequency 14 and/or the sensed unintended radiative emissions 16 may include process 174 for conducting terminal navigation to the sensed unintended radio frequency 14 and/or the sensed unintended radiative emissions 16. Guidance method 100 and/or guidance system 10 may include any steps, processes, devices, means, etc. for process 174 for conducting terminal navigation to the sensed unintended radio frequency 14 and/or the sensed unintended radiative emissions 16. In select embodiments, as best shown in FIGS. 4-5, the sensed unintended radio frequency 14 and/or the sensed unintended radiative emissions 16 may be specific electromagnetic radiation source 40 associated with common frequency ranges of radio and/or radar, including, but not limited to, existing satellite dishes as shown in FIG. 4, and/or existing radio towers as shown in FIG. 5. As show, these existing satellite dishes and/or radio towers may emit the unintended radio frequencies 14 and/or the unintended radiative emissions 16, that clearly have an established purpose other than navigation, that can be used for navigational purposes utilizing the disclosed guidance method 100 and/or guidance system 10. Wherein, the triangulation of the sensed unintended radio frequency 14 and/or the sensed unintended radiative emissions 16 may include triangulating the specific electromagnetic radiation source 40, like from such existing satellite dishes as shown in FIG. 4, and/or existing radio towers as shown in FIG. 5, but clearly not limited thereto. Likewise, the conducting terminal navigation to the sensed unintended radio frequency 14 and/or the sensed unintended radiative emissions 16 may include process 176 of conducting terminal navigation to the specific electromagnetic radiation source 40, like from such existing satellite dishes as shown in FIG. 4, and/or existing radio towers as shown in FIG. 5, but clearly not limited thereto. Wherein, guidance method 100 and/or guidance system 10 may be configured to enable navigating to signal of interest 44 with the specific electromagnetic radiation source 40, that may be useful when a global positioning system is not available or is degraded (like via jamming). Guidance method 100 and/or guidance system 10 may be configured to enable precision location of the specific electromagnetic radiation source 40 of electromagnetic emissions configured for the purposes of navigating vehicle 46. Guidance method 100 and/or guidance system 10 may be utilized for navigating vehicle 46 for any purposes, including but not limited to, as examples, safe fuzing of an ordinance, or for other purposes which utilize a location of said electromagnetic emissions from said specific electromagnetic radiation source 40.

Referring now specifically to FIG. 1, a flowchart of an embodiment for disclosed guidance method 100 according to select embodiments of the instant disclosure is shown. FIG. 1 shows an example of the type of data that is measured and the outputs that are calculated while the vehicle 46, vessel, or aircraft is in motion with the electromagnetic signal strength 22 being measured and or calculated by the User or vehicle 46, vessel, or aircraft in order to continue their travel navigating using signal strength 22 as a key part of its means of navigating. As shown in FIG. 1, in select embodiments, when used for an aircraft like UAS 54, the disclosed guidance method 100 may include a cycle of: process 132 of measuring signal strength 22 of the sensed unintended radio frequency 14 and/or the sensed unintended radiative emissions 16 at all of the antennas 28; process 134 for evaluating which direction to apply course corrections 24 or steering; process 136 for applying course correction 24 based on a calculated heading change and airframe input factors and/or flight constants; process 138 of stabilizing flight in new direction; and process 140 of reacquiring the signal strength, comparing old course to a new course heading, and calculating expected signal strength at all of the antennas 28.

Another feature of the disclosed guidance method 100 and/or guidance system 10 may be that in select embodiments it can include providing an Artificial Intelligence (AI) and/or Machine Learning (AIML) computer. In select embodiments, and clearly not limited thereto, the AI and/or AIML computer may be, may be included with, or may be in communication to, operation or flight control computer 20. The AI and/or AIML computer provided may be capable of optimizing calculated course corrections and learning responses over time based on user programmed or other inputs. With this AI and/or AIML computer provided, the disclosed guidance method 100 and/or guidance system 10 may further include using AI and/or (AIML) software on the provided AI and/or AIML computer 20. Wherein, the using the AI and/or AIML software can include: learning, identifying, and prioritizing a variety of signals in the electromagnetic spectrum available to it in order to make decisions based on the likelihood of the signal being weak or not valuable or useful to the guidance method; discarding a signal not of interest; prioritizing strong or certain signals in a specific frequency range, spectrum, or both; and reporting signal strengths 22 back to a user or other location of interest in order to catalog the strong or certain signals, the signals not of interest to discard, or other parameters. Wherein, as shown in FIG. 1, utilizing the provided AI and/or AIML computer and software, guidance method 100 and/or guidance system 10, may further include, after measuring the signal strength at all of the antennas 28, process 154 of reporting the signal strength 22 measured to the onboard operation or flight computer 20 for processing via the AI and/or AML software on the AI and/or AIML computer. Likewise, as shown in FIG. 1, utilizing the provided AI and/or AIML computer and software, the guidance method 100 and/or guidance system 10 may further include, after applying the course correction, process 156 of reporting the signal strength and the course correction to the onboard computer for processing via the AI and/or AML software on the AI and/or AIML computer.

Another feature of the disclosed guidance method 100 and/or guidance system 10 may be that process 120 of utilizing the sensed unintended radio frequency 14 and/or the sensed unintended radiative emissions 16 for navigation may be configured for navigation of vehicle 46, including any type of vehicle. Vehicle 46, as used herein, may generally refer to a machine designed for self-propulsion, usually to transport people, cargo, or both. Although the term vehicle may typically refer to land vehicles, such as human-powered vehicles (e.g. bicycles, tricycles, velomobiles), animal-powered transports (e.g. horse-drawn carriages/wagons, ox carts, dog sleds), motor vehicles (e.g. motorcycles, cars, trucks, buses, mobility scooters) and railed vehicles (trains, trams and monorails), the term vehicle 46 as used herein is much more broad than land vehicles and may also include cable transport (cable cars and elevators), watercraft (ships, boats and underwater vehicles), amphibious vehicles (e.g. screw-propelled vehicles, hovercraft, seaplanes), aircraft (e.g., airplanes, helicopters, gliders, drones, and aerostats) and space vehicles (spacecraft, spaceplanes and launch vehicles). As shown herein (see FIGS. 4-5), in select embodiments, and clearly not limited thereto, vehicle 46 may be UAS 54. Wherein, guidance method 100 and/or guidance system 10 may further include providing connection 52 to operation or flight controls or an onboard operation or flight computer 20 of vehicle 46 through which to affect the instructions for navigation of vehicle 46, like UAS 54. Wherein vehicle 46 utilizing the disclosed guidance method 100 and/or guidance system 10 may be, but is not limited to, un-manned aerial system (UAS) 54, a land vehicle, a vessel, an aircraft, or a system. Wherein, guidance method 100 and/or guidance system 10 may further include process 160 of guiding the UAS 54, the land vehicle, the vessel, the aircraft or the system via the sensed unintended radio frequency 14 and/or the sensed unintended radiative emissions 16. Wherein, guidance method 100 and/or guidance system 10 may further include providing the connection 52 to operation or flight controls or an onboard flight computer 20 of UAS 54, the land vehicle, the vessel, the aircraft or the system through which to affect the instructions for navigation.

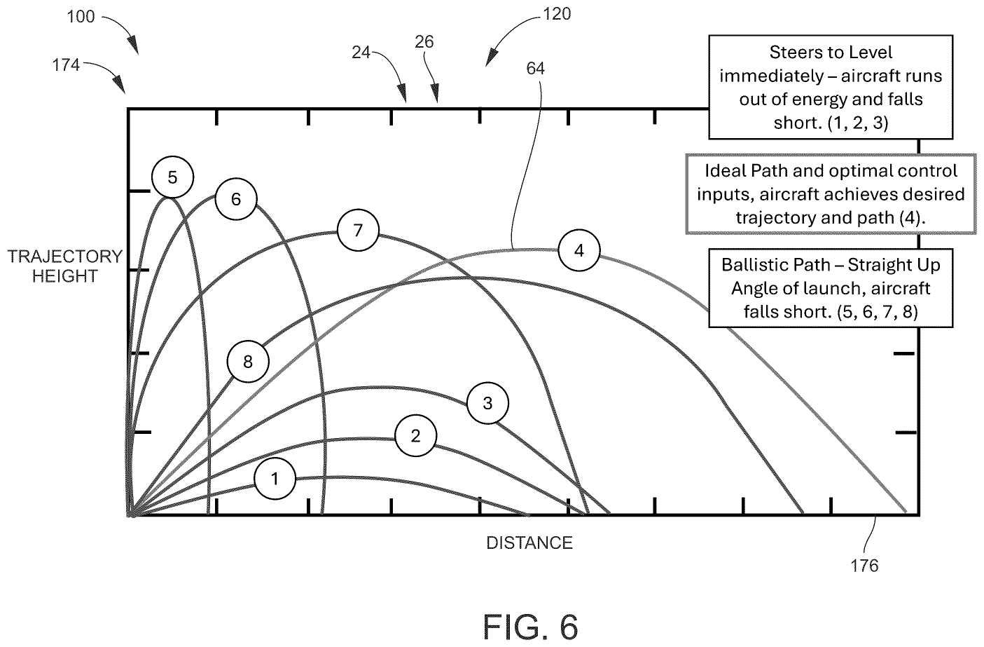

As described and shown herein, in select possibly preferred embodiments, the disclosed guidance method 100 and/or guidance system 10 may be designed and configured for UAS 54. Wherein, guidance method 100 and/or guidance system 10 may include process 162 of guiding UAS 54 via the sensed unintended radio frequency 14 and/or the sensed unintended radiative emissions 16. Wherein, guidance method 100 and/or guidance system 10 may further include providing the connection 52 to operation or flight controls or the onboard flight computer 20 of UAS 54 through which to affect the instructions for flight navigation to provide an ideal path and optical control inputs, whereby the guidance method 100 and/or guidance system 10 may be configured to provide a desired trajectory and path 64 for UAS 54, like for terminal navigation as shown in FIG. 6.

Another feature of the disclosed guidance method 100 and/or guidance system 10 may be that it can further include retrofitting vehicle 46, like UAS 54, with guidance system 10. The process and steps for retrofitting vehicle 46, like UAS, with guidance system 10 may include any processes, steps, devices, means, the like, etc. for adding or retrofitting guidance system 10 to an existing vehicle 46, like an existing UAS 54, or to any new or custom built vehicle 46. The guidance system 10 retrofitted on vehicle 46 may include antennas 28 configured for the sensing of the unintended radio frequency 14 and/or radiative emissions 16. Wherein, in select embodiments, the process for retrofitting vehicle 46 with guidance system 10 with antennas 28 configured for the sensing of the unintended radio frequency 14 and/or radiative emissions 16 may include providing housing device 66 or construction of a housing 66 configured for housing the guidance system 10 including, but not limited to, the antennas 28 and an onboard operation or flight computer 20 with connection 52 to the operation or flight controls of vehicle 46 in order to retrofit, add the capability to, or to install from the outset the capability to detect electromagnetic radiation, to direct vehicle 46 toward or away the electromagnetic radiation source 40. Wherein, the provided housing device 66 may be configured to enable a user to retrofit the guidance system 10 for the guidance method 100 onto an existing vessel, vehicle, aircraft or system to effectuate directional control over the existing vessel, vehicle, aircraft, or system in response to electromagnetic signal strengths 22, frequencies, and other parameters.

In another aspect, the instant disclosure embraces guidance system 10 configured for carrying out the disclosed guidance method 100 in any of the embodiments and/or combinations of embodiments shown and/or described herein. As such, guidance system 10 may be configured to provide navigation to vehicle 46 (like UAS 54) via sensed unintended radio frequency 14 and/or sensed unintended radiative emissions 16. The disclosed guidance system 10 may thus generally include antennas 28 configured to sense the unintended radio frequency 14 and/or the unintended radiative emissions 16. The disclosed guidance system 10 may also include onboard operation or flight computer 20 configured to triangulate the unintended radio frequency 14 and/or the unintended radiative emissions 16 sensed by the antennas 28. Connection 52 between the onboard operation or flight computer 20 and an operational control system of vehicle 46 may also be provided with the disclosed guidance system 10. Wherein, guidance system 10 may be configured to utilize the triangulation of the unintended radio frequency 14 and/or the unintended radiative emissions 16 sensed by the antennas 28 for calculating course corrections 24 for providing navigation to vehicle 46, like UAS 54. In select embodiments of the disclosed guidance system 10, antennas 28 may include two pairs 12 (12a and 12b shown in FIGS. 3-5 referring to separate pairs) of diametrically opposed directional antennas 28. The two pairs 12 of diametrically opposed directional antennas 28 may be configured to sense the unintended radio frequency 14 and/or the unintended radiative emissions 16. In select embodiments, the disclosed guidance system 10 may also include housing device 66. Housing device 66 may be configured for housing components of guidance system 10 including, but not limited to, antennas 28 and onboard operation or flight computer 20 with connection 52 to the operation or flight controls of vehicle 46. Housing device 66 configured for housing the components of guidance system 10 may be configured to allow guidance system 10 to be retrofitted to vehicle 46, add the guidance method 100 capability to vehicle 46, or to install from the outset the capability to detect electromagnetic radiation, to direct vehicle 46 toward or away from the electromagnetic radiation source 40. In another embodiment of the disclosed guidance system 10, omni-directional antenna 28 may also be included. The omni-directional antenna 28 may be configured to deduce relative distance to a sensed unintended radio emission source using the single omni-directional antenna 28 by sensing a perceived signal strength or a received signal strength indicator (RSSI) value.

Referring specifically to FIGS. 3-5, in select possibly preferred embodiments of guidance system 10, vehicle 46 may be un-manned aerial system (UAS) 54. In these embodiments with guidance system 10 included on UAS 54, the onboard flight computer 20 may be connected to the flight controls. Wherein, in select embodiments, and clearly not limited thereto, housing device 66 may be nose cone 68 configured to house the antennas 28 and the onboard flight computer 20 with connections 52 to the flight controls of UAS 54.

In another aspect, the instant disclosure embraces un-manned aerial system (UAS) 54 including the disclosed guidance system 10 and/or guidance method 100 in any of the embodiments and/or combinations of embodiments shown and/or described herein. As such, the disclosed UAS 54 may generally include the disclosed guidance system 10 configured to provide navigation to UAS 54 via sensed unintended radio frequency 14 and/or sensed unintended radiative emissions 16. The guidance system 10 included in UAS 54 may generally include two pairs 12 of diametrically opposed directional antennas 28 configured to sense unintended radio frequency 14 and/or unintended radiative emissions 16. Wherein, guidance system 10 of UAS 54 may be configured to triangulate the sensed unintended radio frequency 14 and/or radiative emissions 16 from the two pairs of directional antennas 28 and utilize the sensed unintended radio frequency 14 and/or radiative emissions 16 for calculating course corrections 24 for providing navigation to UAS 54. In select embodiments, guidance system 10 included in UAS 54 may include the two pairs 12 of diametrically opposed directional antennas 28 configured to sense unintended radio frequency 14 and/or unintended radiative emissions 16 and omni-directional antenna 28 configured to deduce relative distance to a sensed unintended radio emission source using the single omni-directional antenna 28 by sensing a perceived signal strength or a received signal strength indicator (RSSI) value. Wherein, guidance system 10 of UAS 54 may be configured to triangulate the sensed unintended radio frequency 14 and/or radiative emissions 16 from the two pairs of directional antennas 28 and utilize the sensed unintended radio frequency 14 and/or radiative emissions 16, while simultaneously deducing relative distance to a sensed unintended radio emission source from the omni-directional antenna 28 by sensing a perceived signal strength or a received signal strength indicator (RSSI) value for calculating course corrections 24 for providing navigation to UAS 54.

One feature of the disclosed guidance method 100 and/or guidance system 10 for calculating course correction 24 when navigating using unintended radio frequency 14 and/or radiative emissions 16 may be its ability to direct a system such as vehicle 46, vessel, aircraft, the like, or other system toward an electromagnetic radiation signal, emitter, or source.

Another feature of the disclosed guidance method 100 and/or guidance system 10 may be the ability to provide signal strength measurements along a known path in order to compare and contrast projected signal strength with its own estimated position and measured signal strength, and report that comparison back to a base location. It may optionally use code such as artificial intelligence and machine learning code in the onboard operation or flight computer 20 to improve its predictions of accuracy of signal strength predictions over time.

Another feature of the disclosed guidance method 100 and/or guidance system 10 may be its ability to offer a low cost solution with readily replaceable parts in a ground environment rather than being reliant on a network of satellites based in space which are expensive to launch and maintain, or to rely on other more expensive equipment which may be larger in terms of their installed volume or heavier in terms of their mass. With these parts being readily available for application to ground vehicles, unmanned air systems such as fixed wing and rotary wing, and unmanned underwater and unmanned surface vessels, the ability to navigate toward electromagnetic sources using these common components is a key advantage enabling low-cost navigation in an environment which can prohibit other methods of navigation such as GPS, LEO satellite navigation, or other means.

Another feature of the disclosed guidance method 100 and/or guidance system 10 may be the benefit of being applicable to multiple methods of motive power-specifically for aircraft and flying machinery those which follow a ballistic trajectory after their initial launch, and for those which follow a powered-through-flight aircraft or other flying machinery.

Another feature of the disclosed guidance method 100 and/or guidance system 10 may be that the method can be paired with other navigational methods to ensure navigational integrity of position and path while operating in an environment where GPS navigation is not possible and low-earth-orbit (LEO) satellite navigation would be cost- or otherwise-prohibitive.

Another feature of the disclosed guidance method 100 and/or guidance system 10 may be that it can be used as a failsafe for arming or disarming fuzes used for weapons in a defense environment, such that the system does not arm the fuze until it is within a certain percentage of signal strength deemed to be of interest to navigate toward.

In sum, the present disclosure relates to a novel guidance method 100 and guidance system 10 that can be used for un-manned aerial system (UAS) 54 or other vehicles 46, vessels, aircrafts, the like, or system guidance through triangulation of, and/or terminal navigation to, a specific “third party” or “other” unintended electromagnetic radiation source (a radiation source not specifically designed for radio-navigation, I.E. not VORTAC or VOR navigational beacons) associated with the common frequency ranges of radio and/or radar via two pairs of directional antenna 28, and one omni-directional antenna, affixed to a UAS 54 or vehicle 46 in conjunction with proprietary triangulation software. Applying Artificial Intelligence and Machine Learning (AI and or AIML) software further enables the disclosed guidance method 100 and/or guidance system 10 to make most efficient use of the navigational method disclosed herein, and to learn, identify, and prioritize the variety of signals in the electromagnetic spectrum available to it in order to make decisions based on the likelihood of the signal being weak or not valuable/useful to the navigation method and present invention, or to allow the system to be able to discard the signal as not of interest, and to prioritize other, stronger signals, or certain signals in a specific frequency range, or spectrum, or both as well as report those signal strengths back to a User or other location of interest in order to catalog known signals, signals to discard, or other parameters. Guidance method 100 and/or guidance system 10 may enable navigating to a signal of interest in an environment where GPS is not available or is degraded (like via jamming), and may enable precision location of sources of electromagnetic emissions for the purposes of said navigation, like for the purposes of safe fuzing of ordinance, or for other purposes which utilize the location of said electromagnetic emissions.

In the specification and/or figures, typical embodiments of the disclosure have been disclosed. The present disclosure is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein but is limited only by the following claims.

1. A guidance method comprising:
sensing an unintended radio frequency and/or unintended radiative emissions; and
utilizing the sensed unintended radio frequency and/or the sensed unintended radiative emissions for navigation.

2. The guidance method of claim 1, wherein the unintended radio frequency and/or the unintended radiative emissions sensed and utilized for guidance including non-standard, ambient, third-party, or other radio frequencies or radiative emissions not originally designed for navigational purposes.

3. The guidance method of claim 1, wherein the utilizing the sensed unintended radio frequency and/or the sensed unintended radiative emissions comprising calculating course corrections via the sensed unintended radio frequency and/or the unintended radiative emissions.

4. The guidance method of claim 3, wherein the calculating course corrections using the sensed unintended radio frequency and/or the sensed unintended radiative emissions including triangulating the sensed unintended radio frequency and/or the sensed unintended radiative emissions.

5. The guidance method of claim 4 further comprising:
providing two pairs of directional antennas, wherein the triangulation of the sensed unintended radio frequency and/or the sensed unintended radiative emissions including triangulating the sensed unintended radio frequency and/or the sensed unintended radiative emissions via the provided two pairs of the directional antennas; or
providing the two pairs of the directional antennas and an omni-directional antenna, wherein the triangulation of the sensed unintended radio frequency and/or the sensed unintended radiative emissions includes triangulating the sensed unintended radio frequency and/or the sensed unintended radiative emissions via the provided two pairs of directional antennas, while simultaneously deducing relative distance to a sensed unintended radio emission source using the single omni-directional antenna by sensing a perceived signal strength or a received signal strength indicator (RSSI) value.

6. The guidance method of claim 5 further comprising:
providing an onboard operation or flight computer; and
calculating variations in signal strength from the two pairs of the directional antennas and necessary course corrections required to optimize responses of the directional antennas per a desired flight profile via the onboard operation or flight computer.

7. The guidance method of claim 6, wherein the provided two pairs of the directional antennas are diametrically opposed antennas configured for receiving electromagnetic radiation and a measure of signal strength and a frequency in gain and radiation intensity about a direction of travel, and for outputting the measure of signal strength and the frequency in the gain and the radiation intensity, wherein the guidance method including:
outputting steering right to the onboard operation or flight computer if the triangulation of the signal strength of the sensed unintended radio frequency and/or the sensed unintended radiative emissions is on the right of the direction of travel;
outputting steering down to the onboard operation or flight computer if the triangulation of the signal strength of the sensed unintended radio frequency and/or the sensed unintended radiative emissions is down of the direction of travel;
outputting steering left to the onboard operation or flight computer if the triangulation of the signal strength of the sensed unintended radio frequency and/or the sensed unintended radiative emissions is on the left of the direction of travel;
outputting steering up to the onboard operation or flight computer if the triangulation of the signal strength of the sensed unintended radio frequency and/or the sensed unintended radiative emissions is up of the direction of travel;
outputting maintaining course to the onboard operation or flight computer if the triangulation of the signal strength of the sensed unintended radio frequency and/or the sensed unintended radiative emissions has no directional input; or
a combination thereof.

8. The guidance method of claim 4, wherein the triangulation of the sensed unintended radio frequency and/or the sensed unintended radiative emissions including conducting terminal navigation to the sensed unintended radio frequency and/or the sensed unintended radiative emissions.

9. The guidance method of claim 8, wherein the sensed unintended radio frequency and/or the sensed unintended radiative emissions is a specific electromagnetic radiation source associated with common frequency ranges of radio and/or radar, wherein:
the triangulating the sensed unintended radio frequency and/or the sensed unintended radiative emissions including triangulating the specific electromagnetic radiation source; and
conducting terminal navigation to the sensed unintended radio frequency and/or the sensed unintended radiative emissions including conducting terminal navigation to the specific electromagnetic radiation source.

10. The guidance method of claim 9, wherein the guidance method is configured to enable navigating to a signal of interest with the specific electromagnetic radiation source where a global positioning system is not available or is degraded; and
wherein the guidance method is configured to enable a precision location of the specific electromagnetic radiation source of electromagnetic emissions configured for purposes of navigating a vehicle, for purposes of safe fuzing of an ordinance, or for other purposes which utilize a location of said electromagnetic emissions from said specific electromagnetic radiation source.

11. The guidance method of claim 10, wherein the triangulation of the sensed unintended radio frequency and/or the sensed unintended radiative emissions including:
measuring a signal strength of the sensed unintended radio frequency and/or the sensed unintended radiative emissions at all antennas;
evaluating which direction to apply course corrections or steering;
applying the course corrections based on a calculated heading change and airframe input factors and/or flight constants;
stabilizing flight in new direction; and
reacquiring the signal strength, comparing old course to a new course heading, and calculating expected signal strength at all of the antennas.

12. The guidance method of claim 11 further comprising:
providing an Artificial Intelligence (AI) and/or Machine Learning (AIML) computer capable of optimizing calculated of the course corrections and learning responses over time based on user programmed or other inputs;
using AI and/or (AIML) software on the provided AI and/or AIML computer, wherein the using the AI and/or AIML software including:
learning, identifying, and prioritizing a variety of signals in the electromagnetic spectrum available to it in order to make decisions based on a likelihood of the signals being weak or not valuable or useful to the guidance method;
discarding any of the signals not of interest;
prioritizing strong or certain of the signals in a specific frequency range, spectrum, or both;
reporting signal strengths back to a user or other location of interest in order to catalog the strong or certain of the signals, the signals not of interest to discard, or other parameters;
wherein, the guidance method further including:
after measuring the signal strength at all of the antennas, reporting the signal strength measured to the onboard operation or flight computer for processing via the AI and/or AML software on the AI and/or AIML computer; and
after applying the course correction, reporting the signal strength and the course correction to the onboard operation or flight computer for processing via the AI and/or AML software on the AI and/or AIML computer.

13. The guidance method of claim 1, wherein the utilizing the sensed unintended radio frequency and/or the sensed unintended radiative emissions for navigation is configured for navigation of a vehicle;
wherein the guidance method further including providing a connection to operation or flight controls or an onboard operation or flight computer of the vehicle through which to affect the instructions for navigation;
wherein the vehicle is an un-manned aerial system (UAS), a land vehicle, a vessel, an aircraft, or a system, wherein the guidance method further including guiding the UAS, the land vehicle, the vessel, the aircraft or the system via the sensed unintended radio frequency and/or the sensed unintended radiative emissions; and
wherein the guidance method further including providing the connection to operation or flight controls or an onboard flight computer of the UAS, the land vehicle, the vessel, the aircraft or the system through which to affect the instructions for navigation.

14. The guidance method of claim 13 being designed and configured for the UAS, wherein the guidance method including guiding the UAS via the sensed unintended radio frequency and/or the sensed unintended radiative emissions; and
wherein the guidance method further including providing the connection to operation or flight controls or the onboard flight computer of the UAS through which to affect the instructions for flight navigation to provide an ideal path and optical control inputs, whereby the guidance method is configured to provide a desired trajectory and path for the UAS.

15. The guidance method of claim 1 further including retrofitting a vehicle with a guidance system with antennas configured for the sensing of the unintended radio frequency and/or radiative emissions;
wherein the retrofitting the vehicle with the guidance system with the antennas configured for the sensing of the unintended radio frequency and/or radiative emissions including:
providing a housing device or construction of a housing configured for housing the guidance system including the antennas and an onboard operation or flight computer with connection to the operation or flight controls of the vehicle in order to retrofit, add a capability to, or to install from an outset the capability to detect electromagnetic radiation, to direct the vehicle toward the electromagnetic radiation; and
wherein, the provided housing device is configured to enable a user to retrofit the guidance system for the guidance method onto an existing vessel, the vehicle, an aircraft or a system to effectuate directional control over the existing vessel, the vehicle, the aircraft, or the system in response to electromagnetic signal strengths, frequencies, and other parameters.

16. A guidance system configured to provide navigation to a vehicle comprising:
antennas configured to sense an unintended radio frequency and/or unintended radiative emissions;
an onboard operation or flight computer configured to triangulate the unintended radio frequency and/or the unintended radiative emissions;
a connection between the onboard operation or flight computer and an operational control system of the vehicle; and
wherein, the guidance system is configured to utilize the triangulation of the unintended radio frequency and/or the unintended radiative emissions sensed by the antennas for calculating course corrections for providing navigation to the vehicle.

17. The guidance system of claim 16, wherein the antennas include:
two pairs of diametrically opposed directional antennas configured to sense the unintended radio frequency and/or the unintended radiative emissions; or
the two pairs of the diametrically opposed directional antennas and an omni-directional antenna configured to deduce relative distance to a sensed unintended radio emission source by sensing a perceived signal strength or a received signal strength indicator (RSSI) value.

18. The guidance system of claim 17 comprising a housing device configured for housing the guidance system including the antennas and the onboard operation or flight computer with the connection to the operation or flight controls of the vehicle in order to retrofit, add a capability to, or to install from an outset the capability to detect electromagnetic radiation, to direct the vehicle toward the electromagnetic radiation.

19. The guidance system of claim 18, wherein the vehicle is an un-manned aerial system (UAS) and the onboard flight computer is connected to the flight controls, wherein the housing device is a nose cone configured to house the antennas and the onboard flight computer with the connection to the flight controls of the UAS.

20. An un-manned aerial system (UAS) comprising:
a guidance system configured to provide navigation to the UAS, the guidance system including:
two pairs of diametrically opposed directional antennas configured to sense unintended radio frequency and/or radiative emissions;
an omni-directional antenna configured to deduce relative distance to a sensed unintended radio emission source by sensing a perceived signal strength or a received signal strength indicator (RSSI) value; and
wherein, the guidance system included with the UAS is configured to triangulate the sensed unintended radio frequency and/or radiative emissions from the two pairs of the diametrically opposed directional antennas and utilize the sensed unintended radio frequency and/or unintended radiative emissions for calculating course corrections for providing navigation to the UAS, and to deduce relative distance to a sensed unintended radio emission source from the omni-directional antenna by sensing a perceived signal strength or a received signal strength indicator (RSSI) value.
